(19) United States
(12) Patent Application Publication
(10) Pub. No.: US 2026/0128418 A1
(43) Pub. Date: May 7, 2026

(54) SILICONE-BASED FIRE PROTECTION SHEET, ITS PRODUCTION PROCESS, AND BATTERY PACKAGE HAVING THE SHEET

(71) Applicant: DOW SILICONES CORPORATION, Midland, MI (US)

(72) Inventors: Xiangyang TAI, Shanghai (CN); Bizhong ZHU, Auburn, MI (US); Fuming HUANG, Shanghai (CN)

(21) Appl. No.: 19/112,098

(22) PCT Filed: Sep. 16, 2022
(86) PCT No.: PCT/CN2022/119314

§ 371 Date: Mar. 14, 2025

(51) Int. Cl. H01M 10/658; C08K 3/36; C08K 7/22; H01M 10/04; H01M 10/6555; H01M 50/209; H01M 50/211

(52) U.S. Cl. CPC H01M 10/658; C08K 3/36; C08K 7/22; H01M 10/04; H01M 10/6555; H01M 50/209; H01M 50/211; C08K 2201/005

(57) ABSTRACT

The present disclosure relates to a silicone-based fire protection sheet, its production process and battery package having the sheet. The silicone-based fire protection sheet having a structure in which that at least one thermally insulative filler selected from aerogel particles, hollow particles and mesoporous particles are bound in a silicone-based polymeric binder. The amount of the thermally insulative filler ranges from 5 to 40 mass %, and the amount of the silicone-based polymeric binder ranges from 57.5 to 95 mass %, when the total mass of solid content for the silicone-based fire protection sheet is 100 mass %.

### FIELD OF TECHNOLOGY

The present disclosure relates to a silicone-based fire protection sheet, its production process and battery package having the sheet; relates to use of silicone-based fire protection sheet in the battery package; and relates to a method for producing the battery package using the silicone-based fire protection sheet.

### BACKGROUND ART

To control the carbon dioxide emission into atmosphere and suppress the global warming from green-house gas effect, the production of electric vehicle (EV) powered by rechargeable lithium-ion battery (LIB) has started to surge in main geographies on the globe. To increase mileage per charge, EV battery manufactures are targeting at higher energy density battery cathode and anode materials. Meanwhile, the risk of triggering thermal runaway propagation is increasing along with higher energy density, due to the adoption of nickel based lithium metal oxide with higher Ni %. To control the risk of thermal runaway propagation in a battery pack with prismatic or pouch cell, a thermal insulation sheet is placed between two adjacent individual battery cells as a typical passive strategy. Once a thermal runaway happens on one cell, so called fired cell, the temperature inside the cell increases rapidly to 400° C. or above, e.g., 600° C., 800° C. or even 1000° C. Accordingly, the surface of the cell becomes hot, with temperature going beyond 350° C. or above, e.g., 550° C., 750° C. or 950° C. Thermal insulation sheet can delay the heat transfer from the hot surface of the fired cell to the adjacent good cell. Typical thermal insulation sheet adopted by the industry is aerogel sheet with aerogel powders compacted in a fabric mat. Aerogel powders may ensure thermal insulation performance, and the fabric mat holds the powders together into the shape of a sheet. However, because of its intrinsic low density and poor Van der Waal's force between particles, aerogel powders on sheet surface can easily diffuse into atmosphere during handling. That causes pollution to working environment. How to develop fire protection sheet with good thermal insulation performance and clean working environment for battery assembly process is a strong demand in EV battery industry.

Silicone rubber can be ceramified at temperatures triggering its decomposition and condensation reaction. By adding thermally insulative fillers, e.g., aerogel powders or hollow glass beads, into liquid silicone rubber, and then making it cured and/or foamed, the resulted sheet has silicone rubber as matrix with thermally insulative fillers dispersed in. When one cell goes to thermal runaway, silicone matrix in the adjacent sheet can undergo ceramification, changing from soft rubber into rigid inorganic ceramics. Theoretically the sheet after ceramification can delay the heat diffusion from the fire cell to adjacent good cell. On the other hand, as thermally insulative fillers are well bound by silicone rubber, the sheet does not cause air pollution in working environment. However, too much loading of thermally insulative filler into liquid silicone rubber leads to too high viscosity to fit coating process. The pad or sheet fabrication in mass production defines upper limitation of filler volumetric loading in liquid silicone rubber. Within the limitation, thermal insulation performance of final sheet may not be sufficient to prevent thermal runaway propagation. How to develop a fire protection sheet with silicone rubber to bind enough loading of thermally insulative filler together still remained as a challenge.

The invention disclosed a silicone based fire protection sheet for battery pack to effectively prevent the propagation of thermal runaway from a cell in fire to the adjacent ones. The sheet uses silicone to bind thermally insulative fillers like aerogel powder, with thermally insulative filler content from 5 to 40 mass %, and with silicone content>10 mass %, or with polymeric binder content>50 mass %. Below is a more detailed summary of the relevant prior arts found. No prior art has disclosed a battery pack within which a silicone bound aerogel sheet is used, especially sheets with aerogel particle content from 5 to 40 mass %, and with silicone content>10 mass %, or with polymeric binder content>50 mass %.

CN108793932A claims a thermal-insulating energy-saving material and its preparation method, composed of the following raw materials in parts by weight: 30-60 parts of silicon dioxide aerogel, liquid resin, 10-30 parts of modified vitrified micro-bead, 30-50 parts of the closed expanded perlite, 10-20 parts of light aggregate, 8-15 parts of high viscosity clay, 2-8 parts of volcanic ash, 15-35 parts of inorganic fiber, 2-10 parts of dimethyl silicon oil, 1-5 parts of water glass, 2-6 parts of liquid resin 0.5-1.5 parts of dispersant and 40-60 parts of deionized water. Material of this invention has low heat conduction coefficient, low water absorption rate. In the preparation method, it claimed to first heat water to 200° C., put liquid resin and silicone oil into the heated water, and get the liquid resin dissolved in water, then to add fillers and form a slurry. Differentiated from the prior art, the present invention claims >50 wt % of polymeric binder in dried sheet in order to ensure mechanical strength. By calculation, maximum resin loading in dried material in the prior art is 6/(30+10+30+10+8+2+6+0.5)=6/96.5=6.2 wt %. Obviously the material claimed in the prior art cannot be used for thermal runaway propagation prevention sheet in battery. Furthermore, the prior art claimed a process to dissolve liquid resin into hot water before adding fillers. Such liquid resin should not be silicone polymer since it cannot be dissolved in water.

U.S. Pat. No. 10,604,642B2 claims a solid thermally insulating material, essentially free of phyllosilicates, comprising (a) from 70 to 98% by volume of hydrophobic silica aerogel particles having an intrinsic density between 110 and 210 kg/m, (b) from 0.3 to 12% by volume of an organic binder formed by at least one organic polymer (b1) and at least one surfactant (b2), or by an amphiphilic organic polymer (b3), these volume fractions being determined by image analysis on thin sections of the solid material and being given relative to the total volume of the material, the aerogel particles having a particle size distribution that has at least two maxima, with a first maximum corresponding to an equivalent diameter (d) of less than 200 μm, preferably between 25 μm and 150 μm, and a second maximum corresponding to an equivalent diameter (D) between 400 μm and 10 mm, preferably between 500 μm and 5 mm. The prior art did not specify organic binder as silicone polymer. It taught water soluble or dispersible polymers like acrylic polymer or cellulose polymer, which cannot withstand high temperature occurring in battery thermal runaway. Differentiated from the prior art, the present invention discloses silicone polymer as the majority of polymeric binder which ensures the prevention of thermal runaway propagation in battery package. Silicone polymer in binder should be >50 wt %, preferably >60 wt % and more preferably >70 wt %. In some embodiment of the present invention, the vol % of thermally insulative filler is below 60%. Furthermore, the present invention does not require aerogel particle having a particle size distribution exhibiting at least two maxima.

US20070238008A1 claims aerogel-based thermal management systems and methods for vehicles that incorporate aerogel materials to provide insulation and heat shielding. The aerogel materials can be enclosed in an encapsulating material such as a polymer, elastomer, or metal. Differentiated from the prior art, the present invention discloses a technology using silicone emulsion to bind thermally insulative fillers, e.g., aerogel powder, therefore does not need enclosure or encapsulation material.

U.S. Pat. No. 10,501,597B2 discloses a silicone rubber syntactic foam comprising a silicone rubber binder and hollow glass beads, and said silicone rubber syntactic foam fills partially or fully open space of said battery module casing and/or covering partially or totally said battery cells and/or covering partially or totally said module casing, and optionally a lid covering the battery module casing. Differentiated from the prior art, the present invention discloses a sheet material with >15 wt % of thermally insulative filler with mesoporous structure or hollow structure. It is not limited to hollow glass beads, therefore the sheet is not necessarily a silicone rubber syntactic foam. Furthermore, the present invention claims silicone emulsion to mix with filler, and bind filler together in final dry sheet. Silicone emulsion was found essential to satisfy processability requirement.

EP3743466B1 claims a composition comprising a binder comprising one or more siloxane polymers, silicone resins, silicone based elastomer and mixture thereof, and a hydrophilic powder and/or gel selected from one or more amorphous, porous hydrophilic silica, wherein the binder is a solution, an emulsion or a dispersion in water. Differentiated from the prior art, the present invention discloses silicone sheet specifically for prevention of thermal runaway propagation in battery package. The silicone sheet in the present invention comprises thermally insulative fillers not limited by porous hydrophilic silica. It could be one selected from, or the combination of, porous hydrophobic silica, hollow inorganic sphere etc. Both porous hydrophobic silica and hollow glass beads were listed in comparative examples in the prior art. Furthermore, the prior art did not mention the final thermal insulation performance of the composition. The present invention claims the final thermal insulation performance of the silicone sheet should meet specific acceptance criteria, which defines the content of thermally insulative filler, and silicone polymer in total binder.

### RELATED ART DOCUMENTS

1. CN108793932A
2. U.S. Pat. No. 10,604,642B2
3. US20070238008A1
4. U.S. Pat. No. 10,501,597B2
5. EP3743466B1

### SUMMARY OF THE INVENTION

### Problem Solved by the Present Invention

The problem to be solved by the invention is how to better utilize thermally insulative filler like aerogel in a battery pack to prevent battery thermal runaway propagation, without the work environment polluting problem of the aerogel blankets currently available on the market. The concept of the present invention is a sheet (pad) of silicone polymer bound thermally insulative filler like aerogel particle with sufficiently high filler loading, used in a battery pack. The sheet also contains sufficient silicone binder, so that the sheet is non-flammable, and with good mechanical properties for handling.

### Means for Solving the Problem

As the result of earnest research, the present inventors arrived at the present invention through discovering that the problem described above can be solved through a silicone-based fire protection sheet having a structure in which at least one of thermally insulative filler selected from aerogel particles, hollow particles and mesoporous particles are bound in a silicone-based polymeric binder, wherein the amount of said thermally insulative filler ranges from 5 to 40 mass %, the amount of said silicone-based polymeric binder ranges from 57.5 to 95 mass % when the total mass of solid content for the silicone-based fire protection sheet is 100 mass %.

In the silicone-based fire protection sheet described above, the average size or diameter of said thermally insulative filler is not particularly limited but typically ranges from 1 μm to 1.20 mm, and at least 50 mass % of the silicone-based polymeric binder is cured silicone product. In some embodiments of the present disclosure, the aerogel particles have an average size ranging from 0.01 to 1.0 mm in an amount ranging from 15 to 35 mass % when the total mass of solid content for the silicone-based fire protection sheet is 100 mass %. In some embodiments of the present disclosure, the silicone-based polymeric binder is a water-based silicone polymeric binder. In some embodiments of the present disclosure, the silicone-based polymeric binder contains a water-based silicone polymeric binder comprising colloidal silica through condensation curing reaction using alkoxysilane as crosslinking agent. In some embodiments of the present disclosure, the silicone-based polymeric binder further comprises at least one selected from the group consisting of flame-retardant additive, curing catalyst, rheology modifier, anti-foaming additive, wetting-additive, surface treatment agent, colorant, filler other than said thermally insulative filler, anti-oxidant additive, biocide, ultraviolet (UV) stabilizer additive, biocide, and adhesion promoter additive. In some embodiments of the present disclosure, the silicone-based fire protection sheet may be applied for a battery package.

Further, the present disclosure provides a battery package structure where said silicone-based fire protection sheet is fully or partially arranged into a space between at least two adjacent individual battery cells. In some embodiments of the present disclosure, the shape of battery is prismatic or pouch.

In the battery package structure described above, the silicone-based fire protection sheet is a silicone-based product sheet which is cured prior to its arranging into the space between at least two adjacent individual battery cells. In some embodiments of the present disclosure, said silicone-based fire protection sheet is a cured silicone-based product through curing reaction of curable silicone-based composition in the space between at least two adjacent individual battery cells. The preferred shapes of said battery cells are prismatic or pouch shapes which is preferably protected by said silicone-based fire protection sheet.

Further, the present disclosure provides an aqueous curable silicone-based composition which forms into said silicone-based fire protection sheet through curing reaction comprising:
(A) curable silicone-based polymeric binder containing at least 50 mass % of curable silicone polymer in an amount ranging from 57.5 to 95 mass % when the total mass of solid content for the silicone-based fire protection sheet is 100 mass %,
(B) at least one of thermally insulative filler selected from aerogel and hollow particles in an amount ranging 5 to 40 mass % when the total mass of solid content for the silicone-based fire protection sheet is 100 mass %,
(C) curing agent of said component (A),
(D) water, and optionally
(E) at least one selected from the group consisting of flame-retardant additive, curing catalyst, rheology modifier, anti-foaming additive, wetting-additive, surface treatment agent, colorant, filler other than said thermally insulative filler, anti-oxidant additive, biocide, ultraviolet (UV) stabilizer additive, and adhesion promoter additive when the total mass of solid content for the silicone-based fire protection sheet is 100 mass %.

In the aqueous curable silicone-based composition described above, component (A) is silicone-based polymeric binder containing a curable silicone and other curable polymerizable materials with a mass ratio of 50:50 to 100:00. In some embodiments of the present disclosure, component (A) of silicone-based polymeric binder is emulsified or homogeneously dispersed into (D) water.

Further, the present disclosure provides a method of producing said silicone-based fire protection sheet comprising following steps:
Step (I): a step of coating said aqueous curable silicone-based composition as wet-slurry layer onto a substrate which optionally has its release layer to the coating, and
Step (II): a step of forming said silicone-based fire protection sheet by removing water from said coated aqueous curable silicone-based composition under temperature up to 140° C., following to said Step (I).

In some embodiments of the present disclosure, the thickness of the wet-slurry layer of the aqueous curable silicone-based composition ranges from 0.2 to 10.0 mm in said Step (I). The method of producing said silicone-based fire protection sheet further comprises the step of controlling the viscosity and/or flowability of the aqueous curable silicone-based composition by adding water and/or rheology modifier before or at the same timing of said Step (I).

Further, the present disclosure provides a method of producing the battery package structure according to claim 8 comprising following steps:
Step (B-I): a step of filling a space between at least two adjacent individual battery cells fully or partially with the aqueous curable silicone-based composition as wet-slurry layer, and
Step (B-II): a step of forming a silicone-based fire protection sheet in the space between at least two adjacent individual battery calls by removing water from said coated aqueous curable silicone-based composition under temperature up to 140° C., following to said Step (B-I).

### Effects of the Invention

The present invention makes it possible to produce a silicone-based fire protection sheet, which allows the addition of thermally insulative fillers at loading >15 mass % or above; and creates cross-linked polysiloxane backbone as the binder matrix in final sheet. Further, the silicone bound thermally insulative sheet can be placed in a battery pack to isolate a hot spot or a fired cell and prevent/slow thermal propagation into surrounding areas or cells.

It is to be understood that both the foregoing general description and the following detailed description are exemplary and explanatory only and are not restrictive of the invention, as claimed.

### BRIEF DESCRIPTION OF THE DRAWINGS

FIG. 1 is a schematic diagram of an apparatus for testing thermal insulation performance of the silicone-based fire protection sheet according to the present disclosure.

FIG. 2 is back temperature curve of Examples IE-1 to IE-3 and Comparative Example CE1 in the present disclosure, in which the curves are back temperature curves of CE 1, IE 1, IE 2 and IE 3, respectively, from top to bottom.

FIG. 3 is back temperature curve of Comparative Example CE 2 in the present disclosure.

FIG. 4 is back temperature curve of Examples IE 4 and IE 5 in the present disclosure, in which the curves are back temperature curves of IE 4 and IE 5, respectively, from top to bottom.

### DESCRIPTION OF THE PREFERRED EMBODIMENTS

Unless defined otherwise, all technical and scientific terms used herein have the same meaning as commonly understood by one of ordinary skill in the art to which the invention belongs. As disclosed herein, “and/or” means “and, or as an alternative” or “additionally or alternatively”. All ranges include endpoints unless otherwise indicated.

All phrases comprising parentheses denote either or both of the included parenthetical matter and its absence. For example, the phrase “(aqueous) polyurethane” includes, in the alternative, polyurethane and aqueous polyurethane.

As used herein, the term “sheet” or “sheet form” means a flat product in form of pad or sheet which has a thickness. In general, the “sheet” or “sheet form” includes pad-form, sheet-form and other flat-form products having various thickness.

As used herein, the term “thickness” refers to an average of at least three measurements of a dried sheet (e.g., a sheet having a thickness of 0.8-1.2 mm) as measured using an Ames Gage, Model 13C-B2600 (Ames Corporation Waltham Mass.).

As used herein, the terms “aerogel” and “aerogel material” describe a class of structures having a low density, open cell structures, large surface areas, and nanometer scale pore sizes. Aerogel materials can be provided at least in powder, granular, bead, and other suitable forms, and include inorganic, organic, and hybrid organic-inorganic compositions, or some combination of the above forms and/or compositions.

Herein, wording “aerogel” denotes, in the present invention, gels obtained in a known way by the sol-gel route, which have been dried. This wording encompasses both aerogels proper, obtained by supercritical drying of the formed gels, but also gels commonly called “xerogels” obtained by evaporative drying at atmospheric pressure. Xerogels, due to their low cost, are very advantageous when large scale production of the materials of the present invention is considered, while aerogels exhibit more advantageous technical properties but have a high production cost.

The terms “true density” is the quotient obtained by dividing the mass of a sample such as that of glass bubbles by the true volume of that mass of glass bubbles as measured by a gas pycnometer. The “true volume” is the aggregate total volume of the glass bubbles, not the bulk volume.

As used herein, the term “polymer” or “polymeric” refers, in the alternative, to a polymer made from one or more different monomers, such as a copolymer, a terpolymer, a tetrapolymer, a pentapolymer etc., and may be any of a random, block, graft, sequential or gradient polymer.

As used herein, the term “solid” or “solid content” refers to any and every material in the composition other than water and solvents, if any.

As used herein, unless otherwise indicated, the term “average diameter” or “average size” means a weight or volume average diameter as determined by light scattering (LS) using a BI-90 particle size analyzer (Brookhaven Instruments Corp. Holtsville, N.Y.), or a weight or volume average length of irregular-shaped particles measured by image analysis from images captured by any of the instruments such as SEM, TEM, or optical microscope.

As used herein, the phrase “mass %” stands for mass percent or % by mass; and the phrase “wt. %” stands for weight percent or % by weight.

To effectively prevent thermal runaway propagation in the battery pack, it is highly preferred to be >15 mass % or above thermally insulative inorganic filler in the silicone-based fire protection sheet. In the present disclosure, the silicone-based polymeric binder (emulsion) allows the addition of thermally insulative fillers at higher loading (e.g., >15 mass % or above) in the silicone-based fire protection sheet. Liquid silicone rubbers and resins, as well as silicone rubber and resin solutions in organic solvents are candidates for dispersing aerogel particles in, followed by a drying and/or curing process to make the silicone bound aerogel sheet. Organic solvents in silicone polymer or resin solutions need to be accommodated by special equipment in the sheet manufacturing process. When a liquid silicone rubber or resin is used, in some instances and especially when the aerogel particle loading level is very high, the mixture viscosity can be high. Due to high viscosity, it is extremely difficult to process such high loading of thermally insulative fillers in such a liquid silicone rubber or resin. By using the silicone-based polymeric binder emulsion, viscosity of wet slurry obtained after mixing the silicone-based polymeric binder emulsion with thermally insulative fillers can be more easily tuned to meet processability requirement. Further, by using silicone-based polymer as the majority of polymer binder, it creates a cross-linked polysiloxane backbone as the binder matrix in the silicone-based fire protection sheet. A well cross-linked polysiloxane enables good thermal stability up to 350° C., ensuring its thermal insulation performance beneath the temperature. A well cross-linked polysiloxane backbone can be tuned to prefer ceramification at temperature above 350° C., generating inorganic ceramic material, which continues to bind thermally insulative fillers together, providing excellent thermal insulation performance at temperature above 350° C., e.g., 450° C., 650° C., 750° C. and even 950° C. To meet the mechanical strength requirement, total polymer binder in the silicone-based fire protection sheet should be ≥57.5 mass %. To meet the thermal stability performance, silicone-based polymer in total polymer binder should be ≥50 mass %, preferably ≥60 mass %, more preferably ≥70 mass %.

In accordance with the present invention, the silicone-based fire protection sheet has a structure that at least one of thermally insulative filler selected from aerogel particles, hollow particles and mesoporous particles are bound in silicone-based polymeric binder. The amount of said thermally insulative filler ranges from 5 to 40 mass %, from 5 to 35 mass %, from 5 to 30 mass %, from 5 to 25 mass %, from 5 to 20 mass %, from 5 to 15 mass %, from 5 to 10 mass %, from 10 to 40 mass %, from 10 to 35 mass %, from 10 to 30 mass %, from 10 to 25 mass %, from 10 to 20 mass %, from 10 to 15 mass %, from 15 to 40 mass %, from 15 to 35 mass %, from 15 to 30 mass %, from 15 to 25 mass %, from 15 to 20 mass %, from 20 to 40 mass %, from 20 to 35 mass %, from 20 to 30 mass %, from 20 to 25 mass %, from 25 to 40 mass %, from 25 to 35 mass %, from 25 to 30 mass %, from 30 to 40 mass %, from 30 to 35 mass %, or from 35 to 40 mass %; and the amount of said cured silicone-based polymeric binder ranges from 57.5 to 95 mass %, from 57.5 to 90 mass %, from 57.5 to 85 mass %, from 57.5 to 80 mass %, from 57.5 to 75 mass %, from 57.5 to 70 mass %, from 57.5 to 65 mass %, from 57.5 to 60 mass %, from 60 to 95 mass %, from 60 to 90 mass %, from 60 to 85 mass %, from 60 to 80 mass %, from 60 to 75 mass %, from 60 to 70 mass %, from 60 to 65 mass %, from 65 to 95 mass %, from 65 to 90 mass %, from 65 to 85 mass %, from 65 to 80 mass %, from 65 to 75 mass %, from 65 to 70 mass %, from 70 to 95 mass %, from 70 to 90 mass %, from 70 to 85 mass %, from 70 to 80 mass %, from 70 to 75 mass %, from 75 to 95 mass %, from 75 to 90 mass %, from 75 to 85 mass %, from 75 to 80 mass %, from 80 to 95 mass %, from 80 to 90 mass %, from 80 to 85 mass %, from 85 to 95 mass %, from 85 to 90 mass % or from 90 to 95 mass %, wherein the total mass of solid content for the silicone-based fire protection sheet is 100 mass %.

In the present invention, the thermally insulative filler comprise at least one selected from aerogel particles, hollow particles and mesoporous particles. Specifically, the thermally insulative filler applied in this invention may comprise, but is not limited to, aerogel powder, hollow glass beads, perlite, hollow ceramic beads, mesoporous particles, microporous particles, mixtures of mesoporous particles having different pore sizes ranging from 2 nm to 50 nm, and other inorganic filler with mesoporous structure or hollow bubble structure. In some embodiments, the thermally insulative filler in dried sheet has a loading of greater than 15 mass %, from 15 mass % to 30 mass %, from 15 mass % to 25 mass %, from 15 mass % to 20 mass %, from 20 mass % to 30 mass %, from 20 mass % to 25 mass %, or from 25 mass % to 30 mass %.

In an embodiment of the present disclosure, the average diameter or size of said thermally insulative filler ranges from 1 μm (=0.001 mm) to 1.20 mm, from 10 μm (=0.01 mm) to 1.20 mm, 0.01 to 1.20 mm, from 0.01 to 1.00 mm, from 0.01 to 0.80 mm, from 0.01 to 0.60 mm, from 0.01 to 0.40 mm, from 0.01 to 0.20 mm, from 0.03 to 1.20 mm, from 0.20 to 1.00 mm, from 0.20 to 0.80 mm, from 0.20 to 0.60 mm, from 0.20 to 0.40 mm, from 0.40 to 1.20 mm, from 0.40 to 1.00 mm, from 0.40 to 0.80 mm, from 0.40 to 0.60 mm, from 0.60 to 1.20 mm, from 0.60 to 1.00 mm, from 0.60 to 0.80 mm, from 0.80 to 1.20 mm, from 0.80 to 1.00 mm, or from 1.00 to 1.20 mm.

In an embodiment of the present disclosure, the aerogel particles, hollow particles and mesoporous particles having average diameter or size ranging from 0.05 to 1.0 mm, from 0.05 to 0.8 mm, from 0.05 to 0.6 mm, from 0.05 to 1.0 mm, or from 0.05 to 0.8 mm are bound in condensation-reaction cured silicone-based polymeric binder. The preferred amount for said aerogel particles are ranging from 15 to 35 mass %, from 15 to 30 mass %, from 15 to 25 mass %, from 15 to 20 mass %, when the total mass of solid content for the silicone-based fire protection sheet is 100 mass %.

In the present invention, the aerogel particles, hollow particles and mesoporous particles may have true density below 0.25 gram per cubic centimeter (g/cc), from 0.001 g/cc to 0.25 g/cc, from 0.05 g/cc to 0.20 g/cc, from 0.05 g/cc to 0.15 g/cc, from 0.05 g/cc to 0.10 g/cc, from 0.10 g/cc to 0.25 g/cc, from 0.10 g/cc to 0.20 g/cc, from 0.10 g/cc to 0.15 g/cc, from 0.15 g/cc to 0.25 g/cc, from 0.15 g/cc to 0.20 g/cc, or from 0.20 g/cc to 0.25 g/cc; and may have thermal conductivity below 0.1 W/m·K, from 0.01 W/m·K to 0.1 W/m·K, from 0.01 W/m·K to 0.06 W/m·K, from 0.01 W/m·K to 0.03 W/m·K, from 0.03 W/m·K to 0.1 W/m·K, from 0.03 W/m·K to 0.0.6 W/m·K or from 0.06 W/m·K to 0.1 W/m·K.

In the present invention, the aerogel particles can be provided in any suitable form, such as granular, powder, and bead form. The chemical compositions of aerogel particles include inorganic, organic, hybrid organic-inorganic compositions, or any combination thereof. Any combination of the above-mentioned forms and/or compositions can be used in the present invention. Optionally, the aerogel particles can be coated with one or more materials such as a polymer or elastomer, or treated with a treating agent such as a silane. A variety of different aerogel compositions can be used, including inorganic, organic, and hybrid organic-inorganic compositions. Inorganic aerogels are generally based upon metal oxide compounds including, but not limited to: silica, titania, zirconia, alumina, hafnia, yttria, or based on various carbides, nitrides or any combination of the preceding. Organic aerogels can be based on compounds including, but not limited to: urethanes, resorcinol formaldehydes, polyimide, polyacrylates, chitosan, polymethyl methacrylate, members of the acrylate family of oligomers, trialkoxysilylterminated polydimethylsiloxane, polyoxyalkylene, polyurethane, polybutadiene, a member of the polyether family of materials or combinations thereof. Examples of organic-inorganic hybrid aerogels include, but are not limited to: silica-PMMA, silica-chitosan or a combination of the aforementioned organic and inorganic compounds. In certain circumstances, organic polymer or organic-inorganic hybrid polymers can be heat treated to yield carbon or inorganic based mesoporous or microporous materials including aerogels.

The term “hollow particles” is understood to mean particles having a dense or low porosity shell and a free space within the shell. The hollow particles according to the present invention have a shell in which the thickness thereof can be controlled. In the present invention, the hollow particle may comprises hollow glass particle and hollow ceramic beads.

In the present invention, the mesoporous particles have a pore size ranging from 2 nm to 50 nm, have a large specific surface area and a three-dimensional pore structure. According to the classification of chemical composition, mesoporous materials are generally divided into silicon-based and non-silicon-based mesoporous materials. The non-silicon-based mesoporous materials include transition metal oxides, phosphates and sulfides, etc. for example, silicon Aluminophosphates (SAPOs) formed after partial P is replaced by Si in the aluminophosphate based molecular sieve materials, activated carbon with large internal surface area and high pore capacity.

In the silicone-based fire protection sheet, the silicone-based polymeric binder may be cured fully or partially, e.g., a totally-cured silicone-based polymeric binder or a semi-cured silicone-based polymeric binder via a condensation reaction. Alternatively, the silicone-based polymeric binder may be curable, water-based or solvent-based binder resin (i.e., in a non-cured state), which can be applied in sheet-form product. Alternatively, the silicone-based polymeric binder may be cured by a hydrosilylation reaction, or condensation reaction, or a free radical initiated curing reaction. In preferred embodiments, the silicone-based polymeric binder is cured. In preferred embodiments, the silicone-based polymeric binder is water-based (i.e., aqueous) for environment-friendly purpose. In more preferred embodiments, the silicone-based polymeric binder may further comprise colloidal silica components. Most preferably, the silicone-based polymeric binder can be cured through condensation reaction of silicone having hydrolysable group and curing agent of hydrolysable silanes or other condensation reaction agent.

The silicone-based polymeric binder can be elastomeric, or rigid, i.e. having a glass transition temperature of higher than room temperature. Silicones are typically made from four representative categories of structural units, i.e. M (R₃SiO—), D (—OSiR₂O—), T (RSiO_{3/2}—), and Q (SiO_{4/2}), where R is a saturated or unsaturated alkyl or aryl group, and the subscript n/2 means the number of oxygen atoms bridging and shared by two Si atoms. Silicone rubbers are predominantly D structure based, while resins are more heavily based on T and Q structural units.

In an embodiment of the present disclosure, at least 50 mass %, at least 55 mass %, at least 60 mass %, at least 65 mass % or at least 70 mass % of the silicone-based polymeric binder is cured silicone product.

In an embodiment of the present disclosure, the silicone-based polymeric binder is a water-based silicone polymeric binder resin. In preferred embodiments of the present disclosure, the silicone-based polymeric binder contains a water-based silicone polymeric binder comprising colloidal silica through condensation curing reaction using alkoxysilane as crosslinking agent. The colloidal silica may be dispersed in water before mixing with the water-based silicone polymeric binder, such that the weight ratio of the colloidal silica (in solid amount) to the silicone polymer in silicone emulsion is ≤0.5. Loading >0.5 may result to too stiff rubber matrix.

In an embodiment of the present disclosure, the silicone-based polymeric binder further comprises at least one selected from the group consisting of flame-retardant additive, curing catalyst, silicone cross-linker, rheology modifier, anti-foaming additive, wetting-additive, surface treatment agent, colorant, filler other than said thermally insulative filler, anti-oxidant additive, ultraviolet (UV) stabilizer additive, biocide, and adhesion promoter additive. In the present invention, the flame retardant additive comprises halogenated flame retardant additive and/or non-halogenated flame retardant additive, in which examples of the halogenated flame retardant additive comprise brominated flame retardant additive such as brominated polymer or oligomers, brominate styrene-butadiene-styrene copolymer (e.g., FR-122P used in the Example), and preferably combinations of the brominated flame retardant additives with antimony trioxide for forming Br—Sb synergetic system; and examples of the non-halogenated flame retardant additive may comprise ammonium polyphosphate, melamine polyphosphate, aluminum hydroxide, magnesium hydroxide, amorphous phosphorus, expandable graphite. In the present invention, the flame retardant additives may be dispersed in or distributed throughout the silicone-based polymeric binder (i.e., a polymer matrix) with a loading in the range of 0˜60 mass % of the dried sheet. The flame retardant additives with a loading >60 mass % may result to insufficient thermal insulation performance required in Battery fire protection application. The rheology modifier is used for tuning viscosity of wet slurry, e.g., in amount of 0˜2 mass % in wet slurry. The silicone cross-linker may comprise TEOS (=tetraethoxysilanes) or NPOS (=n-propyl orthosilicate), in amount of 0˜5 wt % in wet slurry. The curing catalyst comprises dioctyltin dilaurate or others, depending on the curing chemistry. The anti-foaming additive is used for removing air bubbles in wet slurry, e.g., in amount of 0˜5 mass % in wet slurry. The wetting additive is used for surface wetting of hydrophobic filler. The colorants or color master batch may impart desired colors to the silicone-based fire protection sheet. The filler other than said thermally insulative filler comprises, but not limited to, silica, CaCO₃ and hydromagnesite.

In the present invention, the aqueous silicone-based polymeric binder may be curable, which comprises a polyorganosiloxane that contains at least two silicon-bonded hydroxyl or hydrolyzable groups in each molecule. The molecular structure of the polyorganosiloxane may be straight chain, cyclic, branched, dendritic, or network, but a straight chain or a partially branched straight chain is preferred. The hydroxyl or hydrolyzable groups may be present in terminal position on the molecular chain or in side chain position on the molecular chain or in both positions. The hydrolyzable group can be exemplified by the alkoxy group, alkoxyalkoxy group, acetoxy group, oxime group, enoxy group, amino group, aminoxy group, and amide group, wherein C₁₋₁₀ alkoxy, e.g., methoxy, ethoxy, n-propoxy, isopropoxy, n-butoxy, t-butoxy, hexyloxy, cyclohexyloxy, octyloxy, decyloxy, and so forth, and C₂₋₁₀ alkoxyalkoxy, e.g., methoxymethoxy, methoxyethoxy, ethoxymethoxy, methoxypropoxy, and so forth, are preferred.

Unsubstituted monovalent hydrocarbyl groups and substituted monovalent hydrocarbyl groups are examples of the silicon-bonded organic groups other than the hydroxyl or hydrolyzable groups. C₁₋₁₀ unsubstituted monovalent hydrocarbyl groups are preferred for the unsubstituted monovalent hydrocarbyl groups from the standpoint of the emulsification-boosting action. The unsubstituted monovalent hydrocarbyl can be exemplified by C₁₋₁₀ alkyl such as methyl, ethyl, n-propyl, isopropyl, butyl, t-butyl, hexyl, octyl, decyl, and so forth; C₃₋₁₀ cycloalkyl such as cyclopentyl, cyclohexyl, and so forth; C₂₋₁₀ alkenyl such as vinyl, allyl, 5-hexenyl, 9-decenyl, and so forth; C₆₋₁₀ aryl such as phenyl, tolyl, xylyl, and so forth; and C₇₋₁₀ aralkyl such as benzyl, methylbenzyl, phenethyl, and so forth. Preferred thereamong are the C₁₋₁₀ alkyl, C₆₋₁₀ aryl, and C₂₋₁₀ alkenyl, wherein methyl and phenyl are particularly preferred.

The substituted monovalent hydrocarbyl group can be exemplified by groups provided by replacing all or a portion of the hydrogen atoms in the aforementioned unsubstituted monovalent hydrocarbyl groups, and particularly in the C₁₋₁₀ alkyl and phenyl, with a halogen atom such as fluorine, chlorine, and so forth; an epoxy functional group such as glycidyloxy, epoxycyclohexyl, and so forth; a methacrylic functional group such as methacryloxy and so forth; an acrylic functional group such as acryloxy and so forth; an amino functional group such as the amino group, aminoethylamino, phenylamino, dibutylamino, and so forth; a sulfur-containing functional group such as the mercapto group, the tetrasulfide group, and so forth; or a substituent group such as alkoxy, hydroxy carbonyl, alkoxycarbonyl, and so forth.

The following are specific examples of the substituted monovalent hydrocarbyl group: 3,3,3-trifluoropropyl, perfluorobutylethyl, perfluorooctylethyl, 3-chloropropyl, 3-glycidoxypropyl, 2-(3,4-epoxycyclohexyl)ethyl, 5,6-epoxyhexyl, 9,10-epoxydecyl, 3-methacryloxypropyl, 3-acryloxypropyl, 1,1-methacryloxylundecyl, 3-aminopropyl, N-(2-aminoethyl)aminopropyl, 3-(N-phenylamino)propyl, 3-dibutylaminopropyl, 3-mercaptopropyl, 3-hydroxycarbonylpropyl, methoxypropyl, and ethoxypropyl.

The viscosity of the silicone-based polymeric binder at 25° C. is not particularly limited; however, taking into consideration the strength of the cured sheet of the present invention and the handling characteristics during its production, the silicone-based polymeric binder has a viscosity at 25° C. preferably of 50 mPa·s to 2,000,000 mPa·s, more preferably of 100 mPa·s to 500,000 mPa·s, and even more preferably of 500 mPa·s to 100,000 mPa·s.

The silicone-based polymeric binder can be a diorganopolysiloxane that is endblocked at both molecular chain terminals by the hydroxyl group. Such a diorganopolysiloxane endblocked at both molecular chain terminals by the hydroxyl group can be exemplified by a polyorganosiloxane represented by the general formula HO(R₂SiO)ₘH in this formula denotes the same silicon-bonded unsubstituted and substituted monovalent hydrocarbyl groups other than the hydroxyl or hydrolyzable groups as described above, wherein C₁₋₁₀ alkyl, C₆₋₁₀ aryl, and C₂₋₁₀ alkenyl are preferred and methyl and phenyl are particularly preferred. The subscript m is an integer with a value of at least 2 and preferably is a number that provides a viscosity at 25° C. from 50 mPa·s to 2,000,000 mPa·s.

In the present invention, preferred aqueous silicone-based polymeric binder which can be cured through condensation reaction is commercially available. For example, DOWSIL™ 8005 Waterborne Resin, DOWSIL™ 8004 Waterborne Resin, Dowsil™ IE-2404 can be purchased from DOW SILICONES CORPORATION or its affiliate. Such curable silicone-based polymeric binder or mixture thereof can be cured by removing water under heating up to 140 C.

In the present invention, the binder as used may be a mixture of the curable silicone-based polymeric binder and other organic polymeric binder resin/rubber composition. In an embodiments of the present invention, said other organic polymeric binder resin/rubber composition comprises, but not limited to, polyurethane binder, polyacrylate/polyacrylic acid binder, epoxy resin binder, phenolic resin binder, polyamide binder, polyester binder, polyolefin binder, polystyrene binder, and ethylene-vinyl acetate copolymer. In preferred embodiments, the amount of the curable silicone-based polymeric binder is at least 50 mass %, at least 55 mass %, at least 60 mass %, at least 65 mass %, at least 70 mass %, at least 75 mass %, at least 80 mass %, at least 85 mass % of the mixture. Specifically, an aqueous mixture of said silicone-based polymeric binder and polyurethane binder is preferred to apply in this invention, and said mixture of aqueous binder resin can be cured by removing water under heating up to 140° C.

In the present invention, the aqueous curable silicone-based composition may form into said silicone-based fire protection sheet through curing reaction, which comprises:
(A) a curable silicone-based polymeric binder containing at least 50 mass %, at least 55 mass %, at least 60 mass %, at least 65 mass % or at least 70 mass % of curable silicone polymer, wherein the curable silicone-based polymeric binder ranges from 57.5 to 95 mass %, from 57.5 to 90 mass %, from 57.5 to 85 mass %, from 57.5 to 80 mass %, from 57.5 to 75 mass %, from 57.5 to 70 mass %, from 57.5 to 65 mass %, from 57.5 to 60 mass %, from 60 to 95 mass %, from 60 to 90 mass %, from 60 to 85 mass %, from 60 to 80 mass %, from 60 to 75 mass %, from 60 to 70 mass %, from 60 to 65 mass %, from 65 to 95 mass %, from 65 to 90 mass %, from 65 to 85 mass %, from 65 to 80 mass %, from 65 to 75 mass %, from 65 to 70 mass %, from 70 to 95 mass %, from 70 to 90 mass %, from 70 to 85 mass %, from 70 to 80 mass %, from 70 to 75 mass %, from 75 to 95 mass %, from 75 to 90 mass %, from 75 to 85 mass %, from 75 to 80 mass %, from 80 to 95 mass %, from 80 to 90 mass %, from 80 to 85 mass %, from 85 to 95 mass %, from 85 to 90 mass % or from 90 to 95 mass %;
(B) at least one of thermally insulative filler selected from hollow particles including mesoporous particles such as aerogels and/or microporous particles in an amount ranging from 5 to 40 mass %, from 5 to 35 mass %, from 5 to 30 mass %, from 5 to 25 mass %, from 5 to 20 mass %, from 5 to 15 mass %, from 5 to 10 mass %, from 10 to 40 mass %, from 10 to 35 mass %, from 10 to 30 mass %, from 10 to 25 mass %, from 10 to 20 mass %, from 10 to 15 mass %, from 15 to 40 mass %, from 15 to 35 mass %, from 15 to 30 mass %, from 15 to 25 mass %, from 15 to 20 mass %, from 20 to 40 mass %, from 20 to 35 mass %, from 20 to 30 mass %, from 20 to 25 mass %, from 25 to 40 mass %, from 25 to 35 mass %, from 25 to 30 mass %, from 30 to 40 mass %, from 30 to 35 mass %, or from 35 to 40 mass %;
(C) curing agent of said component (A),
(D) water, and optionally
(E) at least one selected from the group consisting of flame-retardant additive, curing catalyst, rheology modifier, anti-foaming additive, wetting-additive, surface treatment agent, colorant, filler other than said thermally insulative filler, anti-oxidant additive, ultraviolet (UV) stabilizer additive, biocides, and adhesion promoter additive
when the total mass of solid content for the silicone-based fire protection sheet is 100 mass %.

In an embodiment of the present disclosure, component (A) is silicone-based polymeric binder containing a curable silicone and other curable polymerizable materials, in which said other curable polymerizable materials are in amount of 0 mass % to 30 mass %, 10 mass % to 30 mass %, 20 mass % to 30 mass %, 0 mass % to 20 mass %, 0 mass % to 10 mass %, 20 mass % to 30 mass %, 10 mass % to 20 mass %, based on the total mass of the silicone-based polymeric binder. Before mixing, component (A) of silicone-based polymeric binder may be firstly emulsified or homogeneously dispersed into (D) water.

As (C) curing agent of said component (A), crosslinkable silane or condensation curing agent is exemplified. Typically, hydrolysable silanes (e.g. TEOS (tetraethoxysilanes), MTMS (Methyltrimethoxysilane), NPOS (n-propyl orthosilicate) and mixture thereof) are preferred to be applied as component (C)

In the present invention, the method of producing said silicone-based fire protection sheet comprises:
(1) mixing a silicone-based polymeric binder emulsion with thermally insulative fillers in water solution to form a wet slurry or paste;
(2) applying the wet slurry or paste on a substrate, e.g., a release paper, wherein a layer of the wet slurry or paste has a thickness in the range of 0.2 mm-10 mm, 0.2 mm-5 mm, or 2 mm˜10 mm (in the present invention, thickness<0.2 mm may make it easier to create pinhole on the wet film; and thickness>10 mm makes it difficult to remove water and form crack-free dry sheet;
(3) removing water by putting the wet film under a temperature up to 140° C. and air circulation to form a dry sheet, in which a temperature beyond 140° C. may result in crack and other defects on the sheet.

In embodiments of the present invention, the method of producing said silicone-based fire protection sheet may further comprise: before mixing with thermally insulative fillers in water solution, adding one or more ingredients selected from colloidal silica, cross-linker, catalyst, rheology modifier, anti-foaming additive, wetting additives, colorants, other fillers, biocide, anti-oxidant additive and UV stabilizers to the silicone-based polymeric binder emulsion.

In embodiments of the present invention, the method of producing said silicone-based fire protection sheet may further comprise: after adding thermally insulative fillers into the silicone-based polymeric binder emulsion, adding one or more ingredients selected from colloidal silica, cross-linker, catalyst, rheology modifier, anti-foaming additive, wetting additives, colorants, other fillers, biocide, anti-oxidant additive and UV stabilizers to the wet slurry or paste.

In embodiments of the present invention, the method of producing said silicone-based fire protection sheet may further comprise: adding some water into the wet slurry or paste to tune its flowability. Water amount to be added is to ensure marginally good flowability of the homogenous slurry for coating. Depending on the solid content of emulsion and the loading of filler, it may not need to add water if the flowability of slurry is sufficient for coating into certain wet film thickness. If the filler loading goes beyond a certain volumetric concentration, the slurry is not flowable, consequently it is hard to coat the slurry into a wet film with uniform thickness, water is to be added to enhance flowability. In some cases, thickener loading is to be added accordingly to mention certain viscosity. On the other hand, it should be avoided to add too much water, due to several problems occur simultaneously. One is the waste of energy consumption to dry out the excessive amount of water. The second is the increase of volumetric concentration of porous pore and channels left in final pad by water evaporation, which may deteriorate thermal insulation performance. The third one is the additional amount of thickener required to keep slurry viscosity. That amount of thickener remains in final pad and may have negative impact to mechanical performance.

In embodiments of the present invention, the method of producing said silicone-based fire protection sheet may further comprise: coating a second layer of the wet slurry or paste on top of dried layer resulted from above step (3), then further drying. If desired, the method may further comprise coating a third layer of the wet slurry or paste on top of dried second layer. Optionally, the method of the present invention may repeat the steps of coating and drying for several times.

In embodiments of the present invention, the method of producing said silicone-based fire protection sheet may further comprise: removing the dry sheet from the substrate such as a release paper.

In the present invention, the silicone-based fire protection sheet comprising 5-40 wt. % of aerogel particles, hollow particles and mesoporous particles as well as ≥57.5 wt. % of polymeric binder which can be silicone alone or a mixture of silicone and organic polymers may be used in a secondary battery pack comprising at least one battery module casing, in which the casing comprises a plurality of battery cells which are electrically connected to one another. The preferred shapes for said battery cells are prismatic or pouch shapes, which is preferably protected by said silicone-based fire protection sheet.

In embodiments of the present invention, a battery package structure is described wherein said silicone-based fire protection sheet is fully or partially arranged into a space between at least two adjacent individual battery cells. When said battery package structure is prepared, the silicone-based fire protection sheet can be cured by removing water prior to its arranging into the space between at least two adjacent individual battery cells. In this production method of the battery package structure, “cured” or “half-cured” silicone-based fire protection sheet can be arranged (including inserted) fully or partially into a space between at least two adjacent individual battery cells to prevent the heat transfer from the hot surface of the “fired” cell caused by its thermal runaway propagation to the adjacent good cell.

Also, the silicone-based fire protection sheet can be arranged in the space between at least two adjacent individual battery cells through curing reaction by removing water of a curable silicone-based composition in said space. In this embodiments of the present invention, the battery package structure is prepared using curable silicone-based composition which can be cured into said silicone-based fire protection sheet. More specifically, this production method of the battery package structure comprises following steps: Step (B-I): a step of filling a space between at least two adjacent individual battery cells fully or partially with said aqueous curable silicone-based composition as wet-slurry layer, and Step (B-II): a step of forming a silicone-based fire protection sheet in the space between at least two adjacent individual battery calls by removing water from the aqueous curable silicone-based composition as coated under a temperature up to 140° C., following to Step (B-I).

Considering its procedural requirements in the battery assembly process or required fire-protection performance of the battery package structure, any of said production methods can be employed to arrange the silicone-based fire protection sheet into the space between at least two adjacent individual battery cells.

The silicone-based fire protection sheet fills partially or fully open space of said battery module casing and/or covering partially or totally said battery cells, and/or covering partially or totally said module casing, and optionally a lid covering the battery module casing. The silicone-based fire protection sheet is obtained by dispersing thermally insulative fillers into polymeric binder emulsion, coating to certain wet thickness, and forming the final sheet with thermally insulative inorganic filler, after drying out water. Thermally insulative inorganic filler has mesoporous structure or hollow structure, with true density below 0.25 g/cc. The silicone-based fire protection sheet can also be assembled between water cooling plate and metal plate of battery case to prevent heat diffusion between water cooling plate and metal plate of battery case. The silicone-based fire protection sheet is obtained by dispersing thermally insulative fillers into polymeric binder emulsion, coating to certain wet thickness, and forming the final sheet with thermally insulative inorganic filler, after drying out water. Thermally insulative inorganic filler has mesoporous structure or hollow structure, with true density below 0.25 g/cc. It could be pre-fabricated and then assembled into battery case. It can also be fabricated by coating the slurry obtained by dispersing thermally insulative fillers into polymeric binder emulsion onto the inner face of metal plate of battery case, and forming a thermally insulative coating layer sheet after drying out water.

### EXAMPLES

Some embodiments of the invention will now be described in the following examples, wherein all parts and percentages are by weight unless otherwise specified.

The information of the raw materials used in Examples is listed in the following Table 1:

TABLE 1
Raw materials used in Examples

| Grade | Description | Sources |
|---|---|---|
| Dowsil ™ 8005 | Silicone emulsion, solid % ~50 mass %; | Dow |
| water borne resin | Condensation reaction curability | Chemical |
| Syntegra ™ | Polyurethane dispersion, solid % ~55 | Dow |
| YS-3000 | mass % | Chemical |
| FR-122P | Brominated Butadiene/styrene block | ICL |
| | copolymer, CAS # 1195978-93-8, Br: | |
| | 65% | |
| Sb₂O₃ | Purity: 99.8%. | Hsikwang |
| | | Shan |
| | | Twinkling |
| | | Star Co. |
| | | LTD |
| ENOVA ™ | Aerogel Particle, silica, | CABOT |
| IC3110 | [(trimethylsilyl)oxy] modified, CAS# | |
| | 102262-30-6. Bulk density | |
| | 0.06~0.15 g/cc, particle size 100 | |
| | μm~700 μm | |
| S-15 | Hollow glass bubbles, true density: | 3M |
| | 0.13~0.16 g/cc, calculated thermal | |
| | conductivity at 21° C. as 0.055 W/m · K | |
| | D10 < 25 μm, D50 < 55 μm, D90 < | |
| | 90 μm, Top < 95 μm | |
| Keltrol ® CG | Xanthan Gum, natural rheology | CP Kelco |
| | modifier | |
| Tego ™ | antifoam emulsion based on organo- | Evonik |
| Antifoamer 4-88 | modified siloxanes, active content: | |
| | 40% | |

### Inventive Examples 1-5 (IE 1-5) and Comparative Examples 1-3 (CE 1-3)

In Inventive Examples 1-5 of the present disclosure, the silicone-based fire protection sheets were produced using those raw materials and their amounts described in Table 2. Comparative Examples 1-3 were provided here as control.

TABLE 2
Formulations used in Examples

| | CE1 | CE2 | CE3 | IE1 | IE2 | IE3 | IE4 | IE5 |
|---|---|---|---|---|---|---|---|---|
| Dowsil 8005 (g) | 100 | | 100 | 100 | 100 | 100 | 70 | |
| Syntegra YS- | | 100 | | | | | | |
| 3000 (g) | | | | | | | | |
| D.I. water (g) | | 120 | 150 | 100 | 120 | 150 | | 190 |
| FR-122P (g) | 6 | | 6 | 6 | 6 | 6 | | |
| Sb₂O₃ (g) | 2 | | 2 | 2 | 2 | 2 | | |
| Keltrol CG (g) | 0.5 | 0.5 | 0.5 | 0.5 | 0.5 | 0.5 | 0.5 | 0.5 |
| Anti-foamer 4-88 (g) | 1 | 1 | 2 | 2 | 1 | 1 | 0.5 | 1 |
| IC3110 (g) | | 24 | 28 | 12 | 16 | 24 | | 25 |
| S-15 (g) | | | | | | | 15 | |
| Syntegra YS-3000 (g) | | | | | | | | 25 |
| for loose sheet | | | | | | | | |
| Dowsil 8005 (g) | | | | | | | | 75 |
| for loose sheet | | | | | | | | |
| impregnation | | | | | | | | |

For IE1-4 and CE1-3, they involved three steps:
Step 1: Formulating wet slurries;
Step 2: Coating the wet slurries on a substrate and removing water to provide dried sheets; and
Step 3: Testing thermal insulation performance of dried sheets at high temperature.

Detail description about the steps were provided as below:

### Step 1: Formulating Wet Slurry

Into a 1 liter plastic cup, Dowsil 8005, D.I. water (if required), FR-122P (if required) and Sb₂O₃ (if required) were added and mixed with a Cowles blade, with a stirring speed at 300 rpm to form homogeneous slurry. Then Keltrol CG powder was slowly added under stirring at 300 rpm to ensure dissolving of powder and avoid agglomeration of Keltrol CG powder. After it was fully dissolved and viscosity build up, IC3110 or S-15 (if required) was added gradually under stirring at 300 rpm, to make homogeneous slurry.

### Step 2: Coating the Wet Slurries on a Substrate and Removing Water to Provide Dried Sheets

The slurry obtained in Step 1 was coated on PTFE sheet with a knife doctor, so as to form a wet sheet with a thickness of 2.5 mm. The wet sheet was dried at 90° C. oven for 1 hour, to get a dried sheet.

### Step 3: Thermal Insulation Performance of Sheet at High Temperature.

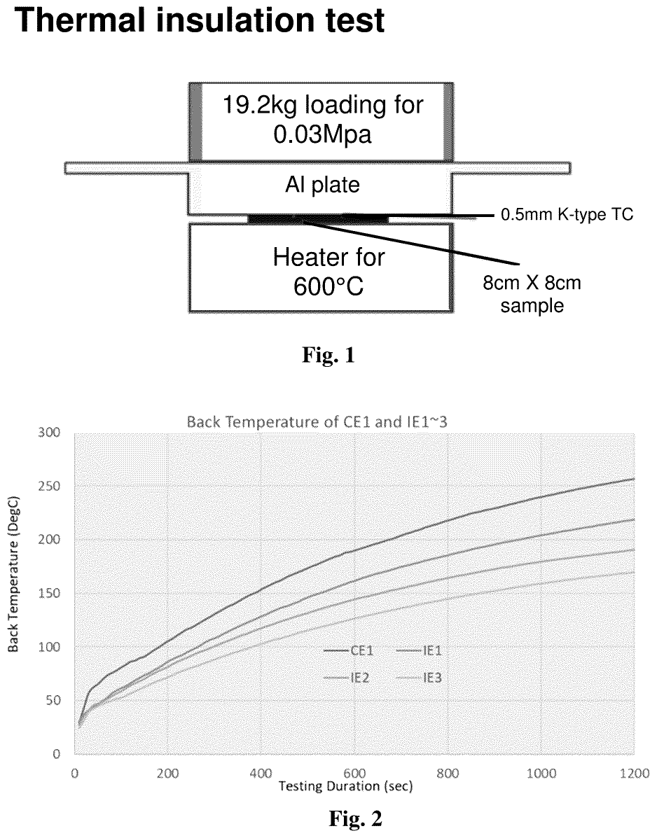

The dried sheet was cut into 8 cm×8 cm square, put on a heat stage stabilized at 630° C. temperature, mounted Al plate with two K-type thermal couples with O.D. at 0.5 mm partially embedded in 0.4 mm groove closely contact the back surface of the specimen to record back temperature. All surfaces of the Al plate were well covered by thermal insulative asbestos board to control heat diffusion. Steel loading was further mounted on Al plate to make 0.03 Mpa pressure on specimen. Illustration of the set up was referred to FIG. 1. All mounting was completed in 10 sec since the specimen attached to the heat stage. Heat stage temperature of 630° C. was calibrated by mounting a square 8 cm×8 cm aerogel sheet/pad with thickness of 4±0.2 mm onto the Al plate, with one thermocouple on the center the sheet directly contacting heat stage surface. The calibration lasted at least 20 min for a stable 630° C. heat stage surface before starting thermal insulation performance test. In the test, back temperature was recorded from the time the specimen attached to the heat stage. The test lasted for 20 min. Original thickness of sheet specimen was measured at four corners, and an average thickness was calculated. During the testing, a feeler gauge was used to insert between the heat stage and Al plate to measure thickness right before ending the test. Both back temperature change with testing duration, and thickness change were recorded.

For IE5, it also involved above three steps, but step 2 was divided to two parts:
2-1: Coating wet slurry on the substrate and removing water to get a dried loose sheet;
2-2: impregnating Dowsil 8005 (i.e., polymer emulsion) into the dried loose sheet and removing water to get a final sheet.

Details of Step 2-1 and step 2-2 were as below:

### Step 2-1:

A slurry of mixture of Syntegra YS-3000, water, Keltrol CG thickener, anti-foamer 4-88 and aerogel filler IC3110 was coated on PTFE sheet with a knife doctor, so as to form a wet sheet with a thickness of 2.5 mm. The wet sheet was dried in 90° C. oven for 1 hour, to get a dried loose sheet.

### Step 2-2:

Dowsil 8005 was impregnated evenly into the loose sheet by brush. The impregnated loose sheet was put into oven at 90° C. for 1 hour to get a dried sheet.

TABLE 3
Mass % and vol % of fillers in Inventive Examples 1-5 (IE 1~5) and Comparative Examples
1-3 (CE 1-3), together with the thermal insulation performance testing results

| | CE1 | CE2 | CE3 | IE1 | IE2 | IE3 | IE4 | IE5 |
|---|---|---|---|---|---|---|---|---|
| mass % of | 0.00 | 30.00 | 32.00 | 16.78 | 21.33 | 28.92 | 29.56 | 32.36 |
| thermally | | | | | | | | |
| insulative | | | | | | | | |
| filler in | | | | | | | | |
| dried sheet | | | | | | | | |
| Binder | 84.7 | 68.8 | 57.1 | 69.9 | 66.7 | 60.2 | 69.0 | 66.3 |
| mass % in | | | | | | | | |
| dried sheet | | | | | | | | |
| Polysiloxane | 84.7 | 0.0 | 57.1 | 69.9 | 66.7 | 60.2 | 69.0 | 48.5 |
| mass % in | | | | | | | | |
| dried sheet | | | | | | | | |
| Polysiloxane | 100.0 | 0.0 | 100.0 | 100.0 | 100.0 | 100.0 | 100.0 | 73.2 |
| mass % in | | | | | | | | |
| binder | | | | | | | | |
| Dry sheet | Very | Very | Unacceptable | Good | Good | Marginal | Good | Good |
| strength | good | Good | | | | | | |

Thermal Insulation Performance Testing

| | | | | | | | | |
|---|---|---|---|---|---|---|---|---|
| Original | 2.5 | 2.6 | NA | 2.5 | 2.5 | 2.5 | 2.9 | 2.6 |
| sheet | | | | | | | | |
| thickness | | | | | | | | |
| (mm) | | | | | | | | |
| Sheet | 2.5 | 1.4 | NA | 2.5 | 2.5 | 2.5 | 2.9 | 1.8 |
| thickness | | | | | | | | |
| after test | | | | | | | | |
| (mm) | | | | | | | | |
| Back | 190 | 208 | NA | 165 | 148 | 130 | 148 | 140 |
| Temperature | | | | | | | | |
| (° C.) | | | | | | | | |
| 300 sec | 131 | 159 | NA | 108 | 101 | 88 | 104 | 91 |
| 600 sec | 190 | 198 | NA | 161 | 144 | 126 | 143 | 135 |
| 900 sec | 229 | 237 | NA | 195 | 173 | 152 | 169 | 164 |
| 1200 sec | 257 | 262 | NA | 219 | 191 | 170 | 187 | 182 |
| Fire during | No | No | NA | No | No | No | Small | No |
| the test | | | | | | | Fire | |

Total binder mass % in dried sheet is critical for mechanical strength. CE3 showed that the dry sheet strength was unacceptable and easily grinded to powder by finger, since the binder loading in CE3 was below 60%. IE3 showed marginal sheet strength with 60.2 mass % binder, which suggested that >60 mass % of the binder in dried sheet was required to ensure sufficient sheet strength for downstream assembling operation in battery module and package production.

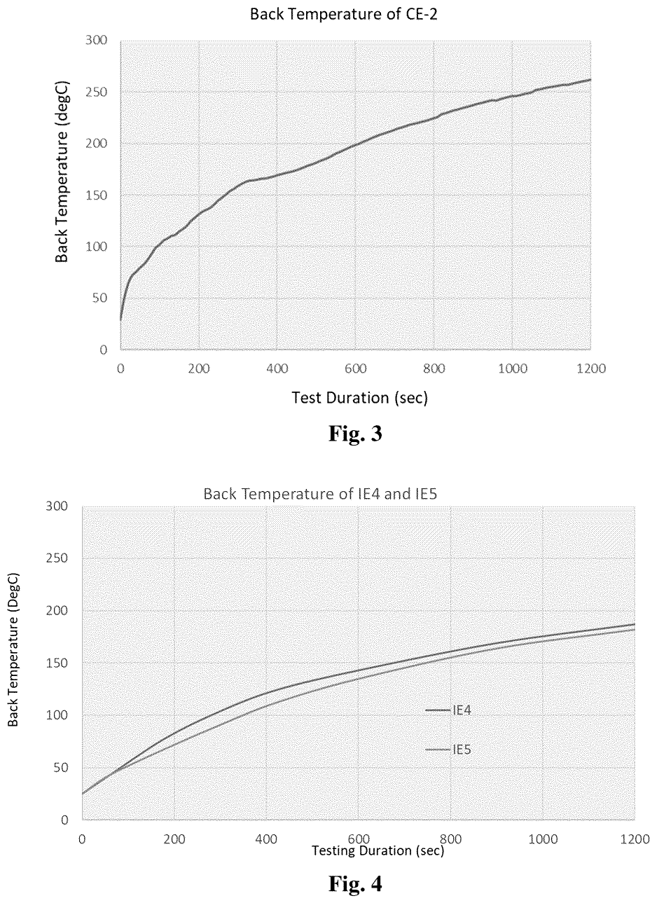

Compared with CE1 (i.e., a silicone sheet without any thermally insulative fillers), IE1-5 showed much lower back temperature (See FIGS. 2-4), suggesting significantly improved thermal insulation performance. To meet the acceptance criteria in practical design, for a thermal insulation sheet with a thickness of 2.5 mm, it required lower back temperature being below 220° C., preferably below 170° C., when being put on a heat stage at 630° C. with 0.03 Mpa pressure for 20 min. All inventive Examples of the present invention meet the criteria in practical design. The amount of thermally insulative fillers in IE1 was close to the bottom line, suggesting >15 wt % of thermally insulative fillers was preferred to keep good heat protection performance.

Polysiloxane wt % in binder is critical for thermal insulation performance. CE2 showed that with polyurethane as main binder, thermal insulation performance was even worse than CE1, i.e., a silicone sheet without any thermally insulative fillers. IE5 showed that when polysiloxane was majority of binder, thermal insulation performance was good. It suggested polysiloxane mass % in binder should be >50%, preferable >60%, more preferrable >70%.

All Examples except IE4 did not cause any firing during the test, due to the addition of flame retardant additives in the sheet. IE4 caused a small fire, but was extinguished quickly when it was removed from the heat stage at the end of the test. The small fire can generally be eliminated by adding some flame retardant additives.

### Testing and Evaluation

Acceptance criteria included three parts: mechanical strength, thermal insulation at high temperature, and flame ignition at heat stage test.

### Mechanical Strength

Mechanical strength of thermal insulation sheet is evaluated by bending. If a sheet with 2.5 mm thickness can be bended from one end to the other end with 1 cm radius for more than 50 times without any change or damage, it is ranked as “very good”. If it can be bended for more than 10 times without obvious damage, it was ranked as “good”. If it can be bended for more than 1 times without obvious damage, it was ranked as “marginal”. If it cannot be bended, it is ranked “unacceptable”. As the sheet is rolled up in mass production, at least one time of bending is required. Mechanical strength of sheet in CE3 and IE3 suggested suggesting >60 mass % binder loading is needed.

### Thermal Insulation at High Temperature

Thermal insulation at high temperature is evaluated by heat stage test. In practical design, for a thermal insulation sheet with thickness 2.5 mm, it requires the back temperature below 220° C., when being putting on a heat stage at 630° C. with 0.03 Mpa pressure for 20 min. All inventive examples meeting the criteria. IE1 is close to the bottom line, suggesting >15 mass % of thermally insulative fillers is preferred to keep good heat protection performance. On the other hand, CET and IE5 showed polysiloxane mass % in binder should be the majority to ensure sufficient thermal insulation performance. Polysiloxane mass % in binder should be >50%, preferable >60%, more preferrable >70%.

### Flame Ignition at Heat Stage Test

Flame ignition of thermal insulation sheet is evaluated by fire appearance during the test. If the sheet caused fire, possibly it generates additional heat, which should be avoided. IE1˜3 showed that by adding flame retardant additives, flame ignition can be avoided.

1. A silicone-based fire protection sheet having a structure in which at least one thermally insulative filler selected from aerogel particles, hollow particles and mesoporous particles are bound in a silicone-based polymeric binder, wherein the amount of the thermally insulative filler ranges from 5 to 40 mass %, the amount of the silicone-based polymeric binder ranges from 57.5 to 95 mass % when the total mass of solid content for the silicone-based fire protection sheet is 100 mass %.

2. The silicone-based fire protection sheet according to claim 1, wherein the thermally insulative filler has an average size of from 1 μm to 1.20 mm, and at least 50 mass % of the silicone-based polymeric binder is cured silicone.

3. The silicone-based fire protection sheet according to claim 1, wherein the aerogel particles have an average size ranging from 0.01 to 1.0 mm in an amount ranging from 15 to 35 mass % when the total mass of solid content for the silicone-based fire protection sheet is 100 mass %.

4. The silicone-based fire protection sheet according to claim 1, wherein the silicone-based polymeric binder is a water-based silicone polymeric binder.

5. The silicone-based fire protection sheet according to claim 1, wherein the silicone-based polymeric binder contains a water-based silicone polymeric binder comprising colloidal silica.

6. The silicone-based fire protection sheet according to claim 1, wherein the silicone-based polymeric binder further comprises at least one selected from the group consisting of flame-retardant additive, curing catalyst, rheology modifier, anti-foaming additive, wetting-additive, surface treatment agent, colorant, filler other than the thermally insulative filler, anti-oxidant additive, biocide, ultraviolet (UV) stabilizer additive and adhesion promoter additive.

7. The silicone-based fire protection sheet according to claim 1, which is applied for battery package.

8. A battery package structure wherein the silicone-based fire protection sheet according to claim 1 is fully or partially arranged into a space between at least two adjacent individual battery cells.

9. The battery package structure according to claim 8, wherein the shape of battery is prismatic or pouch.

10. The battery package structure according to claim 8, wherein the silicone-based fire protection sheet is a silicone-based sheet which is cured prior to its arranging into the space between at least two adjacent individual battery cells.

11. The battery package structure according to claim 8, wherein the silicone-based fire protection sheet is a cured silicone-based product through curing reaction of a curable silicone-based composition in the space between at least two adjacent individual battery cells.

12. An aqueous curable silicone-based composition which forms into the silicone-based fire protection sheet according to claim 1 through curing reaction, comprising:
(A) a silicone-based polymeric binder containing at least 50 mass % of curable silicone polymer in an amount ranging from 57.5 to 95 mass %;
(B) at least one thermally insulative filler selected from aerogel particles, hollow particles and mesoporous particles in an amount ranging 5 to 40 mass %;
(C) a curing agent; and
(D) water;
(E) optionally, at least one component selected from the group consisting of flame-retardant additives, curing catalysts, rheology modifiers, anti-foaming additives, wetting-additives, surface treatment agents, colorants, fillers other than the thermally insulative fillers, anti-oxidant additives, biocides ultraviolet (UV) stabilizers, and adhesion promoters;
when the total mass of solid content for the silicone-based fire protection sheet is 100 mass %.

13. The aqueous curable silicone-based composition according to claim 12, wherein component (A) is a silicone-based polymeric binder containing a curable silicone polymer and other curable/polymerizable materials, in which the other curable/polymerizable materials are in amount of 0 mass % to 30 mass %.

14. The aqueous curable silicone-based composition according to claim 12, wherein component (A) is emulsified or homogeneously dispersed into water (D).

15. A method of producing a silicone-based fire protection sheet, the method comprising following steps:
(I) coating the aqueous curable silicone-based composition according to claim 12 as a wet-slurry layer onto a substrate which optionally has a release layer; and
(II) forming the silicone-based fire protection sheet by removing water from the aqueous curable silicone-based composition as coated under a temperature up to 140° C., following step (I).

16. The method of producing the silicone-based fire protection sheet according to claim 15, wherein the wet-slurry layer of the aqueous curable silicone-based composition has a thickness of from 0.2 to 10.0 mm in step (I).

17. The method of producing the silicone-based fire protection sheet according to claim 15, further comprising the step of (III) controlling the viscosity and/or flowability of the aqueous curable silicone-based composition by adding water and/or a rheology modifier before or at the same timing of step (I).

18. A method of producing the battery package structure according to claim 8, comprising a step of arranging the silicone-based fire protection sheet fully or partially into a space between at least two adjacent individual battery cells.

19. A method of producing a battery package structure, the method comprising following steps:
(B-I) filling a space between at least two adjacent individual battery cells fully or partially with the aqueous curable silicone-based composition according to claim 12 as a wet-slurry layer; and
(B-II) forming a silicone-based fire protection sheet in the space between at least two adjacent individual battery cells by removing water from the aqueous curable silicone-based composition as coated under a temperature up to 140° C., following step (B-I).
